(19) United States
(12) Patent Application Publication
(10) Pub. No.: US 2026/0298253 A1
(43) Pub. Date: Oct. 1, 2026

(54) MOTOR AND BLOWER

(71) Applicant: NIDEC CORPORATION, Kyoto (JP)

(72) Inventors: Akinobu SUMIJI, Kyoto (JP); Hiroki FURUICHI, Kyoto (JP); Tsuyoshi YASUMURA, Kyoto (JP); Takaya OTSUKI, Kyoto (JP); Akihiro YUDATE, Kyoto (JP)

(21) Appl. No.: 19/576,347

(22) Filed: Mar. 24, 2026

(30) Foreign Application Priority Data
Mar. 27, 2025 (JP) 2025-053860

(51) Int. Cl. F04D 25/06; H02K 11/33; H02K 21/22

(52) U.S. Cl. CPC F04D 25/06; H02K 11/33; H02K 21/22; H02K 2211/03

(57) ABSTRACT

A motor includes a stator and a housing. A direction parallel or substantially parallel to a rotation shaft of the motor is defined as an axial direction. The housing includes a base portion extending in a radial direction orthogonal or substantially orthogonal to the axial direction, and a stator support portion protruding from the base portion toward one axial side to support the stator. The stator includes a flexible printed circuit board including a first board portion on one axial side of the base portion, a second board portion on another axial side of the base portion, and a connection portion connecting the first board portion and the second board portion in the axial direction. The second board portion includes a connection pad at a position overlapping the base portion in the axial direction on the another axial side.

### CROSS-REFERENCE TO RELATED APPLICATIONS

The present application claims priority under 35 U.S.C. § 119 to Japanese Patent Application No. 2025-053860, filed on Mar. 27, 2025, the entire contents of which are hereby incorporated herein by reference.

### 1. Field of the Invention

The present disclosure relates to motors.

### 2. Background

In the related art, a motor used for a blower is known. Such a motor includes a board.

In the known motor, it is necessary to connect a connector connected to a lead wire drawn out from a board to a connector on the actual machine side on which the motor is mounted.

### SUMMARY

An example embodiment of a motor of the present disclosure includes a stator and a housing. A direction parallel or substantially parallel to a rotation shaft of the motor is defined as an axial direction, and the housing includes a base portion that extends in a radial direction orthogonal or substantially orthogonal to the axial direction, and a stator support portion that protrudes from the base portion toward one axial side and supports the stator. The stator includes a flexible printed circuit board. The flexible printed circuit board includes a first board portion on one axial side of the base portion, a second board portion on another axial side of the base portion, and a connection portion connecting the first board portion and the second board portion in the axial direction. The second board portion includes a connection pad at a position overlapping the base portion in the axial direction on the another axial side.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a longitudinal sectional view of a blower according to an example embodiment of the present disclosure.

FIG. 2 is a diagram of a blower according to an example embodiment of the present disclosure as viewed from one axial side.

FIG. 3 is a diagram of a blower according to an example embodiment of the present disclosure as viewed from another axial side.

FIG. 4 is a diagram (partially enlarged view) of a stator and a housing as viewed from one axial side.

FIG. 5 is a partial sectional perspective view of the stator.

FIG. 6 is a longitudinal cross-sectional view of a blower according to an example embodiment of the present disclosure (similar to FIG. 1).

FIG. 7 is a partial vertical sectional view illustrating a relationship between a body portion of an impeller and a drawing hole.

FIG. 8 is a diagram of a blower according to a modification of an example embodiment of the present disclosure as viewed from the another axial side.

### DETAILED DESCRIPTION

Hereinafter, example embodiments of the present disclosure will be described with reference to the drawings.

In the present specification, in a blower 1, a direction parallel to a rotational axis J of a motor 2 is referred to as an “axial direction.” In the axial direction, the intake side is referred to as “one axial side Da”, and the exhaust side is referred to as “the other axial side Db”. A direction orthogonal to the rotation axis J is referred to as a “radial direction”. In the radial direction, an orientation toward the rotation axis J is referred to as “radially inward”, and an orientation away from the rotation axis J is referred to as “radially outward”. A rotation direction about the rotation axis J is referred to as a “circumferential direction”.

Note that these terms are merely used for description and are not intended to limit actual positional relationships, directions, names, and the like.

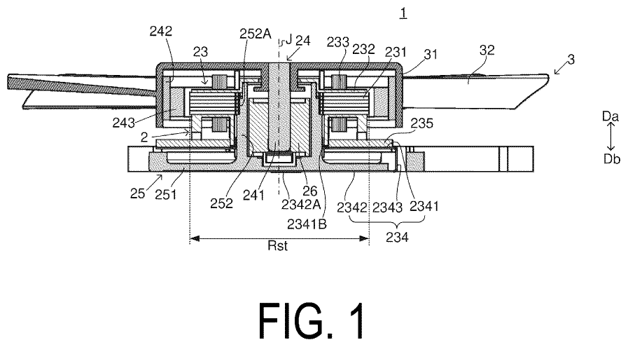

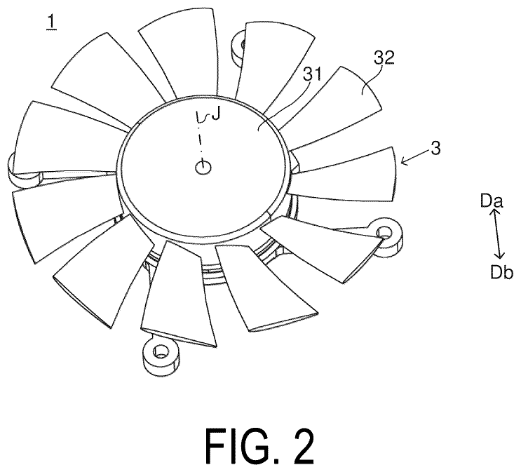

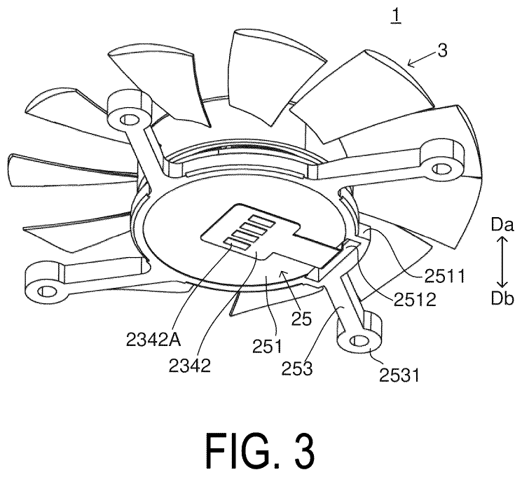

FIG. 1 is a longitudinal sectional view of the blower 1 according to an example embodiment of the present disclosure. FIG. 2 is a diagram of the blower 1 according to the example embodiment of the present disclosure as viewed from one axial side. FIG. 3 is a diagram of the blower 1 according to the example embodiment of the present disclosure as viewed from the other axial side.

The blower 1 includes a motor 2 and an impeller 3, and is formed as an axial fan. The motor 2 rotates the impeller 3 about the rotation axis J extending in the axial direction. That is, the blower 1 includes the motor 2 and the impeller 3 that is rotationally driven by the motor 2.

The motor 2 includes a stator 23, a rotor 24, a housing 25, and a shaft holding portion 26.

The stator 23 includes a stator core 231, an insulator 232, and a coil 233.

The stator core 231 is formed by stacking electromagnetic steel plates such as silicon steel plates in the axial direction. The insulator 232 is made of a resin having insulating properties. The insulator 232 is provided to surround the outer surface of the stator core 231. The coil 233 is formed of a conductive wire wound around the stator core 231, with the insulator 232 interposed therebetween.

The rotor 24 includes a shaft 241, a rotor yoke 242, and a magnet 243.

The shaft 241 is disposed along the rotation axis J. The shaft 241 is made of a metal such as stainless steel and is a columnar member extending in the axial direction. The shaft 241 is supported by the shaft holding portion 26 accommodated in the housing 25 described below so as to be rotatable about the rotation axis J. One axial end portion of the shaft 241 is fixed to a radially central portion of a body portion 31 of the impeller 3, which will be described below.

The rotor yoke 242 has a cylindrical shape and is fixed to an inner circumferential surface of the body portion 31. The magnet 243 is fixed to an inner circumferential surface of the rotor yoke 242 and disposed radially outside of the stator 23. On the magnetic pole surface on the inner circumferential side of the magnet 243, N poles and S poles are alternately arranged in the circumferential direction.

The impeller 3 is made of, for example, resin. The impeller 3 includes a body portion (hub) 31 and a plurality of blade portions 32.

The body portion 31 is fixed to the rotor 24 (shaft 241) and rotates about the rotation axis J extending in the axial direction. The body portion 31 is a cylindrical member including a lid on one axial side. That is, the impeller 3 includes the tubular body portion 31 rotatable about the rotation axis J.

The plurality of blade portions 32 protrude radially outward from an outer circumferential surface of the body portion 31 and are disposed at intervals in the circumferential direction.

The housing 25 includes a base portion 251 and a stator support portion 252.

The base portion 251 has a disk shape including a protruding portion 2511 in a part in the circumferential direction, and expands in the radial direction. The stator support portion 252 protrudes from the base portion 251 toward one axial side. The stator support portion 252 has a cylindrical shape with the rotation axis J as its central axis. The shaft holding portion 26 is disposed inside the stator support portion 252. A step portion 252A is provided on the outer circumferential surface of the stator support portion 252 midway in the axial direction. The stator core 231 is supported by the step portion 252A. Therefore, the stator support portion 252 supports the stator 23.

The stator 23 includes a flexible printed circuit board (FPC) 234. The FPC 234 includes a first board portion 2341 disposed on one axial side of the base portion 251, a second board portion 2342 disposed on the other axial side of the base portion 251, and a connection portion 2343 connecting the first board portion 2341 and the second board portion 2342 in the axial direction.

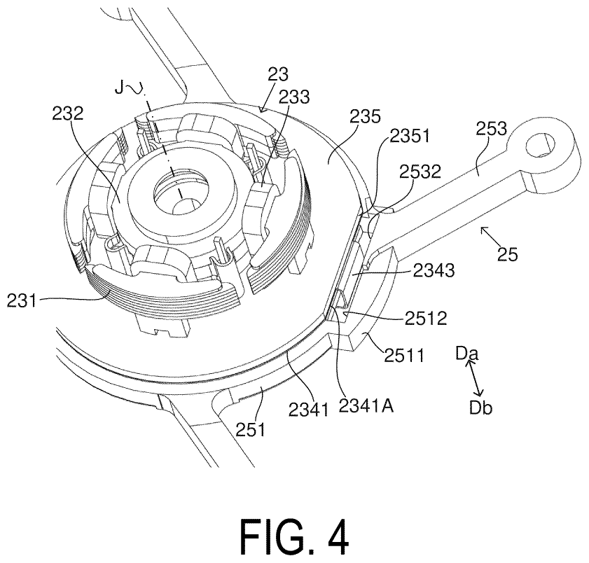

Here, FIG. 4 is a diagram of the stator 23 and the housing 25 as viewed from one axial side. The first board portion 2341 has a disc shape including an edge portion 2341A linearly cut out in a part of an outer circumference portion when viewed in the axial direction. An electronic component such as a motor driver IC that drives the motor 2 is mounted on the first board portion 2341. The first board portion 2341 is provided with a through hole 2341B that penetrates in the axial direction. The through hole 2341B is passed through the outer circumference of the stator support portion 252, and the first board portion 2341 is fitted to the stator support portion 252.

The first board portion 2341 is located on the other axial side of the stator 23 and faces the base portion 251 in the axial direction. The base portion 251 includes a drawing hole 2512 penetrating in the axial direction. The FPC 234 is drawn out from one axial side of the base portion 251 to the other axial side through the drawing hole 2512. Accordingly, the connection portion 2343 is disposed inside the drawing hole 2512, and the second board portion 2342 is located on the other axial side of the base portion 251. The drawing hole 2512 extends in a direction intersecting the radial direction when viewed in the axial direction. By drawing out the FPC 234 through the drawing hole 2512, the torsion of the FPC 234 can be suppressed. In addition, the radial flutter of the FPC 234 can be suppressed.

As illustrated in FIG. 3, the second board portion 2342 includes a connection pad 2342A at a position overlapping the base portion 251 in the axial direction on the other axial side. By fixing the housing 25 to the actual machine, the connection pad 2342A can be reliably brought into contact with the connection pad of the board on the actual machine side by the base portion 251, and the motor 2 can be easily attached to the actual machine. Note that the housing 25 is fixed to the actual machine by an attachment portion 2531 provided at a tip of a support portion 253 described below.

In particular, as illustrated in FIG. 1, the connection pad 2342A is disposed inside a region Rst surrounded by the outer edge of the stator 23 when viewed in the axial direction. This makes it possible to bring the connection pad 2342A into contact with the connection pad on the actual machine side more reliably.

As illustrated in FIG. 4, the stator 23 includes a reinforcing plate 235 that extends in the radial direction. Similarly to the first board portion 2341, the reinforcing plate 235 has a disk shape including an edge portion 2351 that is linearly cut out in a part of an outer circumference portion when viewed in the axial direction. The first board portion 2341 is disposed along the reinforcing plate 235 and is fixed to the reinforcing plate 235 by, for example, an adhesive. The reinforcing plate 235 is provided with a through hole that penetrates in the axial direction. The through hole is passed through the outer circumference of the stator support portion 252, and the reinforcing plate 235 is fitted to the stator support portion 252. The reinforcing plate 235 can suppress the torsion of the first board portion 2341.

As illustrated in FIG. 1, the body portion 31 is disposed on one axial side of the reinforcing plate 235. When the rotor 24 includes the body portion 31, the rotor 24 is disposed on one axial side of the reinforcing plate 235. The first board portion 2341 is disposed on the other axial side of the reinforcing plate 235. The guard by the reinforcing plate 235 can prevent the torsion of the first board portion 2341 from interfering with the rotor 24.

As illustrated in FIG. 4, the radial position of the edge portion 2351, which is a portion of the outer circumference portion of the reinforcing plate 235 that overlaps the drawing hole 2512 in the circumferential position, is radially inward of the radially outer edge of the drawing hole 2512. This facilitates the drawing of the FPC 234 into the drawing hole 2512. The FPC 234 can be prevented from sagging on the radially outward of the edge portion 2351.

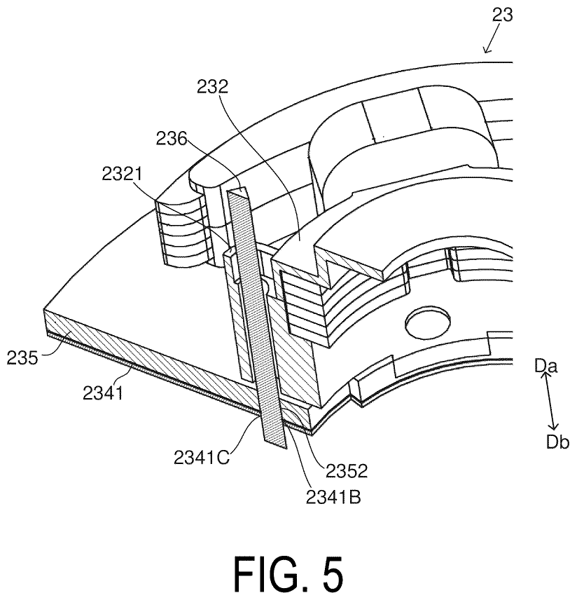

FIG. 5 is a partial sectional perspective view of the stator 23. The insulator 232 includes a plurality of pin holding portions 2321 protruding radially outward from an outer circumference portion in the circumferential direction. A pin 236 is held by each of the pin holding portions 2321. That is, the stator 23 includes the pin 236 held by the insulator 232. The first board portion 2341 and the reinforcing plate 235 include through-holes 2341B and 2352 penetrating in the axial direction at positions overlapping in the axial direction. The first board portion 2341 includes a land 2341C around the through-hole 2341B on the other axial side. The pin 236 is disposed to penetrate the through-holes 2341B and 2352. The other axial end portion of the pin 236 is soldered to the land 2341C. This facilitates the attachment of the FPC 234 and the reinforcing plate 235 to the stator 23. The construction method and process can be made common to a standard motor using no FPC 234.

Note that a lead wire of the coil 233 is wound around some of the plurality of pins 236, and the FPC 234 and the coil 233 are electrically connected to each other. That is, the some of the pins 236 serve both as a conductor and as a FPC 234 holder. Since the lead wire of the coil 233 is not wound around remaining pins 236, the remaining pins 236 are used only for holding the FPC 234.

As illustrated in FIG. 3, the housing 25 includes a support portion 253. The support portion 253 extends radially outward from the outer circumference portion of the base portion 251 and supports the base portion 251. A plurality of (four in FIG. 3) the support portions 253 are provided at intervals in the circumferential direction.

As illustrated in FIG. 4, the circumferential position of a radially inner end portion 2532 of the support portion 253 overlaps the drawing hole 2512. In a standard motor model, a lead wire connected to a board is wired along a support portion. That is, the drawing positions of the lead wire and the FPC 234 are made close to each other, and the structure of the stator can be made common to that of a standard motor model.

As illustrated in FIG. 4, the base portion 251 includes a protruding portion 2511 protruding radially outward from the outer circumference portion of the base portion 251. The radially inner end portion 2532 of the support portion 253 is connected to the protruding portion 2511. The drawing hole 2512 is disposed in the protruding portion 2511. By connecting the support portion 253 to the protruding portion 2511, the length of the support portion 253 can be shortened, and the vibration of the base portion 251 due to the operation of the motor 2 can be suppressed.

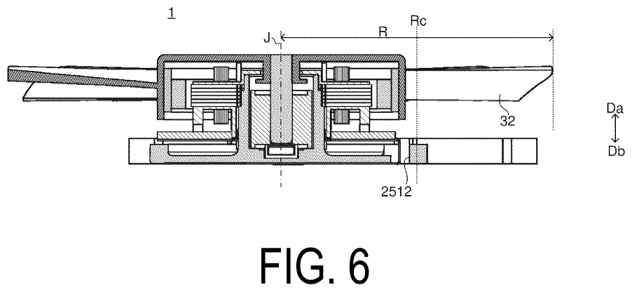

FIG. 6 is a longitudinal cross-sectional view of the blower 1 according to the example embodiment of the present disclosure (similar to FIG. 1). In this way, the drawing hole 2512 is disposed radially inward of a half Rc of a radius R of the radially outer edge of the blade portion 32. This prevents the FPC 234 from fluttering due to the wind from the blade portion 32.

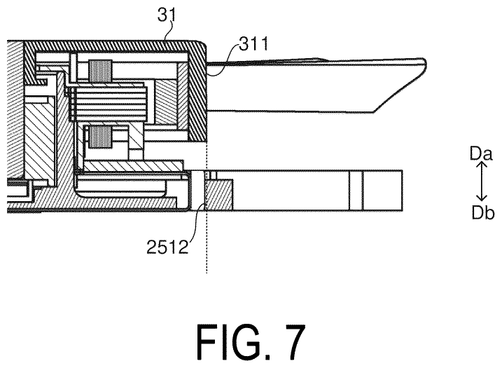

Note that as illustrated in FIG. 7, the drawing hole 2512 may be disposed radially inward of a radially outer edge 311 of the body portion 31. This also prevents the FPC 234 from fluttering due to the wind from the blade portion 32.

Since the housing 25 in the motor 2 (blower 1) according to the above-described example embodiment does not surround the impeller 3 from radially outward (FIG. 3), the air generated when the impeller 3 is rotationally driven by the motor 2 can be supplied to the radially outward of the impeller 3.

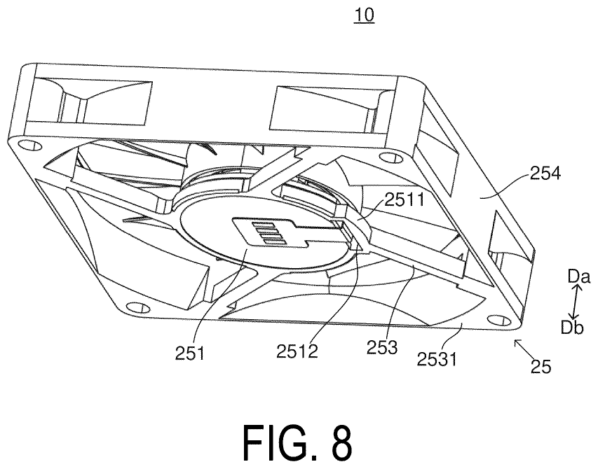

In contrast, FIG. 8 is a diagram of a blower 10 according to a modification of the present disclosure as viewed from the other axial side. The housing 25 in the blower 10 (motor 2) includes a side wall portion 254 that surrounds the impeller 3 from radially outward in a rectangular shape when viewed in the axial direction. The attachment portion 2531 of the support portion 253 is provided at four corners of the side wall portion 254. By providing the side wall portion 254, when the blower 10 is attached to the actual machine, the air can be supplied to the other axial side as much as possible by the impeller 3.

Note that, in this case, by providing the protruding portion 2511 only at the location where the drawing hole 2512 is provided, the area of the base portion 251 as viewed in the axial direction can be made as small as possible, and the air flowing to the other axial side can be prevented from being blocked by the base portion 251.

The arrangement location of the connection pad is not limited to the above-described example embodiment, and the base portion of the housing may be formed to the outside of the region surrounded by the outer edge of the stator when viewed in the axial direction, and the connection pad may be disposed at a location outside the region in the base portion. The base portion may be formed to the outside of the side wall portion of the housing, and the connection pad may be disposed at a location outside the side wall portion in the base portion.

The technical scope of the present disclosure is not limited to the above-described example embodiments. For example, in the above-described example embodiments, the blowers are axial fans, but the motors according to example embodiments of the present disclosure may be applied to blowers as centrifugal fans.

As described above, a motor according to an example embodiment of the present disclosure includes a stator and a housing, a direction parallel or substantially parallel to a rotation axis of the motor being defined as an axial direction, in which the housing includes a base portion extending in a radial direction orthogonal or substantially orthogonal to the axial direction, and a stator support portion protruding from the base portion toward one axial side and configured to support the stator, the stator includes a flexible printed circuit board, the flexible printed circuit board includes a first board portion on one axial side of the base portion, a second board portion on the other axial side of the base portion, and a connection portion connecting the first board portion and the second board portion in the axial direction, and the second board portion includes a connection pad at a position overlapping the base portion in the axial direction on the other axial side (first configuration).

In the first configuration, the base portion may include a drawing hole which penetrates in the axial direction and in which the connection portion is located, and the drawing hole may extend in a direction intersecting with the radial direction when viewed in the axial direction (second configuration).

In the first or second configuration, the stator may include a reinforcing plate extending in the radial direction, and the first board portion may be located along the reinforcing plate (third configuration).

In the third configuration, the rotor may be on one axial side of the reinforcing plate, and the first board portion may be on another axial side of the reinforcing plate (fourth configuration).

In the fourth configuration, the stator may include an insulator and a pin held by the insulator, the first board portion and the reinforcing plate may include through-holes penetrating in the axial direction at positions overlapping in the axial direction, the first substrate portion may include a land around one of the through-holes on the other axial side, the pin may penetrate the through-holes, and an axial end portion of the pin may be soldered to the land (fifth configuration).

In any one of the third to fifth configurations, the base portion may include a drawing hole which penetrates in the axial direction and in which the connection portion is located, and a radial position of an edge portion of an outer circumference portion of the reinforcing plate, which is a portion overlapping the drawing hole in a circumferential position, may be radially inward of a radially outer edge of the drawing hole (sixth configuration).

In the second configuration, the housing may include a support portion extending radially outward from an outer circumference portion of the base portion and configured to support the base portion, and a circumferential position of a radially inner end portion of the support portion may overlap the drawing hole (seventh configuration).

In the seventh configuration, the base portion may include a protruding portion protruding radially outward from the outer circumference portion of the base portion, the radially inner end portion of the support portion may be connected to the protruding portion, and the drawing hole may be in the protruding portion (eighth configuration).

In any one of the first to eighth configurations, the connection pad may be inside a region surrounded by an outer edge of the stator when viewed in the axial direction (ninth configuration).

A blower according to an example embodiment of the present disclosure includes the motor according to any one of the second, seventh, and eighth configurations, and an impeller to be rotationally driven by the motor, in which the impeller includes a body portion having a cylindrical shape rotatable about a rotation axis, a plurality of blade portions which protrude radially outward from an outer circumferential surface of the body portion and are arranged at intervals in a circumferential direction, and the drawing hole is radially inward of a radially outer edge of the body portion (tenth configuration).

A blower according to an example embodiment of the present disclosure includes the motor according to any one of the second, seventh, and eighth configurations, and an impeller to be rotationally driven by the motor, in which the impeller includes a body portion having a cylindrical shape rotatable about a rotation axis, and a plurality of blade portions which protrude radially outward from an outer circumferential surface of the body portion and are arranged at intervals in a circumferential direction, and the drawing hole is radially inward of a half of a radius of a radially outer edge of the blade portion (eleventh configuration).

Example embodiments of the present disclosure can be used for, for example, fans for various applications.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising: a stator; and a housing,
a direction parallel or substantially parallel to a rotation axis of the motor being defined as an axial direction; wherein
the housing includes:
a base portion extending in a radial direction orthogonal or substantially orthogonal to the axial direction; and
a stator support portion protruding from the base portion toward one axial side to support the stator;
the stator includes a flexible printed circuit board;
the flexible printed circuit board includes:
a first board portion on one axial side of the base portion;
a second board portion on another axial side of the base portion; and
a connection portion connecting the first board portion and the second board portion in the axial direction; and
the second board portion includes a connection pad at a position overlapping the base portion in the axial direction on the another axial side.

2. The motor according to claim 1, wherein
the base portion includes a drawing hole which penetrates in the axial direction and in which the connection portion is located; and
the drawing hole extends in a direction intersecting with the radial direction when viewed in the axial direction.

3. The motor according to claim 1, wherein
the stator includes a reinforcing plate extending in the radial direction; and
the first board portion is located along the reinforcing plate.

4. The motor according to claim 3, further comprising:
a rotor on one axial side of the reinforcing plate; wherein
the first board portion is on another axial side of the reinforcing plate.

5. The motor according to claim 4, wherein
the stator includes an insulator and a pin held by the insulator;
the first board portion and the reinforcing plate include through-holes penetrating in the axial direction at positions overlapping in the axial direction;
the first board portion includes a land around one of the through-holes on the another axial side;
the pin penetrates the through-holes; and
an axial end portion of the pin is soldered to the land.

6. The motor according to claim 3, wherein
the base portion includes a drawing hole which penetrates in the axial direction and in which the connection portion is provided; and
a radial position of an edge portion of an outer circumference portion of the reinforcing plate, which is a portion overlapping the drawing hole in a circumferential position, is radially inward of a radially outer edge of the drawing hole.

7. The motor according to claim 2, wherein
the housing includes a support portion extending radially outward from an outer circumference portion of the base portion to support the base portion; and
a circumferential position of a radially inner end portion of the support portion overlaps the drawing hole.

8. The motor of claim 7, wherein
the base portion includes a protruding portion protruding radially outward from the outer circumference portion of the base portion;
the radially inner end portion of the support portion is connected to the protruding portion; and
the drawing hole is in the protruding portion.

9. The motor according to claim 1, wherein the connection pad is inside a region surrounded by an outer edge of the stator when viewed in the axial direction.

10. A blower comprising:
the motor according to claim 2; and
an impeller to be rotationally driven by the motor; wherein
the impeller includes:
a body portion having a cylindrical shape rotatable about a rotation axis; and
a plurality of blade portions which protrude radially outward from an outer circumferential surface of the body portion and are arranged at intervals in a circumferential direction; and
the drawing hole is radially inward of a radially outer edge of the body portion.

11. A blower comprising:
the motor according to claim 2; and
an impeller to be rotationally driven by the motor; wherein
the impeller includes:
a body portion having a cylindrical shape rotatable about a rotation axis; and
a plurality of blade portions which protrude radially outward from an outer circumferential surface of the body portion and are arranged at intervals in a circumferential direction; and
the drawing hole is radially inward of a half of a radius of a radially outer edge of the blade portion.
